(19) United States
(12) Patent Application Publication
(10) Pub. No.: US 2012/0227399 A1
(43) Pub. Date: Sep. 13, 2012

(54) IN-FLOW AIR INJECTION HOUSING

(75) Inventor: James B. Karch, Chicago, IL (US)

(73) Assignee: International Engine Intellectual Property Company, LLC, Lisle, IL (US)

(21) Appl. No.: 13/416,346

(22) Filed: Mar. 9, 2012

Related U.S. Application Data
(60) Provisional application No. 61/451,657, filed on Mar. 11, 2011.

(51) Int. Cl. F02D 21/08; F02M 25/07

(52) U.S. Cl. 60/605.2; 123/568.17

(57) ABSTRACT

An in-flow air injection housing configured to create suction for pulling a combustion gas through an EGR system. The housing includes an orifice that is configured to receive an inner ring. The inner ring includes an outer groove and a plurality of air jets. The housing further includes a supplemental gas inlet, a supply inlet, and a supply outlet. The supply inlet is configured to receive a supplemental gas that flows through the supplemental gas inlet. The supply outlet is positioned to deliver the supplemental gas received by the supply inlet to the outer groove. The supplemental gas may flow from the outer grove through annular air jets positioned along a side of the inner ring. The flow of supplemental gas through the air jets and into combustion gas(es) may provide momentum and/or friction that draws additional combustion gas through the housing.

### RELATED APPLICATIONS

This application claims priority to U.S. Application No. 61/451,657, having a filing date of Mar. 11, 2011, which is incorporated herein by reference in its entirety.

### BACKGROUND

Exhaust gas recirculation (EGR) systems often use exhaust gas to replace a portion of the air that is used during a combustion process by an internal combustion engine. By replacing some of the air used for combustion with exhaust gas, the combustion process may occur at lower temperatures. Such lower temperatures may decrease the amount of nitrogen oxides that are formed during combustion.

Engines often rely on the operation of certain engine components to pull or push air, exhaust gas, or an air/exhaust gas mixture to the intake manifold of the engine. For example, in diesel fueled internal combustion engines, hot exhaust gas that is created by the combustion process may be used to provide heat needed for the operation of one or more turbines. The turbines may then be used to drive one or more air compressors that provide compressed air for use during the combustion of the diesel fuel. The operation of the turbine, or the compressor driven by the turbine, may also be used to pull or push gases through the EGR system. However, when the turbine is operating at relatively low speeds, such as, for example around 0 to 800 revolutions per minutes (RPMs), these functions of the turbine may cause an undesirable reduction in the turbine's power. For example, a drop in turbine power may result in an undesirable reduction in the air/fuel mixture, which may result in lower power being produced by the engine, as well as heavy smoke conditions. Alternatively, a drop in turbine power may reduce the ability of the system to pull or push exhaust gas in an EGR system or the EGR system may be temporarily shut-off, thereby reducing the amount of exhaust gas present during the combustion process.

Reductions in the amount exhaust gas that is mixed with air for the combustion process may result in elevated temperatures and pressures in the ignition chamber that cause auto-ignition, or detonation, of the air-fuel mixture. Such detonation may cause damage to the engine. Additionally, the high temperatures and pressures at which detonation, or spark knock, occurs may also result in an increase in the formation of nitrogen oxides in the exhaust gas, which may present issues with satisfying increasingly stringent emission standards.

### BRIEF SUMMARY

An aspect of the illustrated embodiment is an apparatus for an in-flow air injection system. The apparatus includes a housing that has an orifice configured to receive the placement of an inner ring. The inner ring includes a first sidewall, a second sidewall, an outer groove, and at least one air jet. The outer groove is positioned between at least a portion of the first and second sidewalls. The housing further includes a supplemental gas inlet, a supply inlet, and a supply outlet. The supply inlet and the supply outlet are in fluid communication through a supply gas pathway. The supply inlet is configured to receive a supplemental gas that flows through the supplemental gas inlet. The supply outlet is positioned to deliver the supplemental gas received by the supply inlet to the outer groove. According to certain embodiments, the housing may also include at least one aperture, with at least a portion of the aperture being configured to receive a sensor that senses a gas pressure within the housing.

According to another embodiment, a method is provided for controlling the pressure of a combustion gas passing through an in-flow air injection housing in an EGR system. The method includes determining a speed of a turbine. A supply inlet in the in-flow air injection housing is opened when the speed of the turbine is below a predetermined limit. The method also includes delivering a supplemental gas through the supply inlet of the in-flow air injection housing and to an outer groove of an inner ring. The inner ring is positioned in an orifice of the in-flow air injection housing. The supplemental gas from the outer groove is supplied through a plurality of air jets to a passage of the inner ring. The method also includes drawing combustion gases through the in-flow injection housing through the supply of supplemental gas through the plurality of air jets. The method further includes closing the supply inlet when the turbine attains a predetermined speed.

### BRIEF DESCRIPTION OF SEVERAL VIEWS OF THE DRAWINGS

FIG. 1 is a front perspective view of an in-flow air injection system.

FIG. 2 is a perspective view of a housing for the in-flow air injection system.

FIG. 3 is a cross-sectional view of the in-flow air injection system.

FIG. 4 is an enlarged portion of the cross-section shown in FIG. 3 illustrating a flow pathway as supplied air encounters an outer surface of the inner ring.

FIG. 5 is an exploded view of the in-flow air injection system operably coupled to an intake manifold duct flange and an EGR mixer duct flange.

FIG. 6 is a side cross-sectional view of the in-flow air injection system operably coupled to the intake manifold duct flange and the EGR mixer duct flange.

FIG. 7 is a perspective of the in-flow air injection system operably coupled to an intake manifold duct flange and an EGR mixer duct flange.

### DETAILED DESCRIPTION

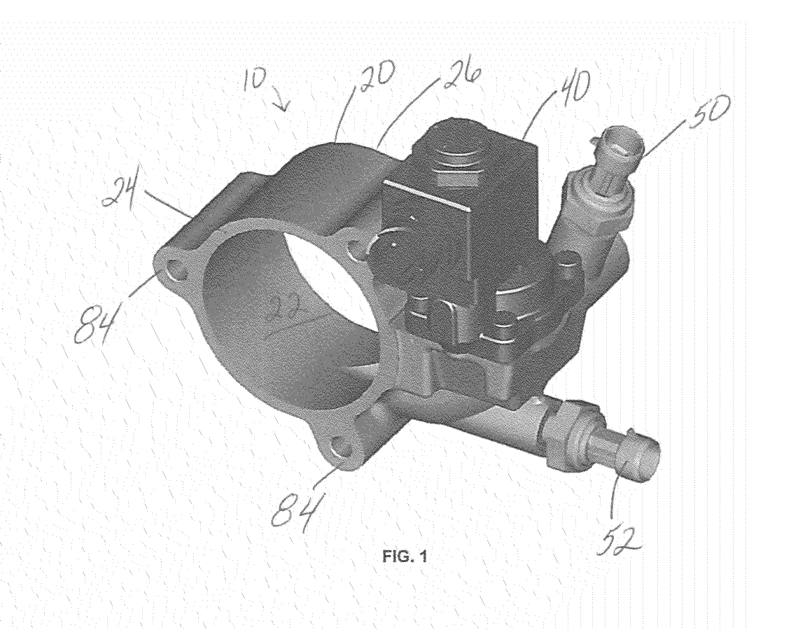

FIG. 1 is a front perspective view of an in-flow air injection system 10. As shown, the in-flow air injection system 10 includes a housing 20 and a controller 40. The housing 20 may be constructed from a variety of materials, including brass, aluminum, bronze, cast iron, and steel, among others. Selection of the material used for the material for the housing 20 may depend on a number of different criteria, including, for example, the application for which the housing 20 will be used. The controller 40 may be secured to the housing 20, such as, for example, through the use of fasteners that threadingly engage mating holes in the housing 20. The housing 20 includes a supplemental gas inlet 21 that may be operably attached to a supplemental gas source, such as an air tank, for example. The controller 40 is configured to control the flow of the supplemental gas into an aperture of the housing 20. For example, the controller 40 may include a valve, such as a piston or diaphragm valve, among others, that assists in controlling when the supplemental gas that enters the housing 20 through the supplemental gas inlet 21 is permitted to flow through into a supply inlet 30 that is in fluid communication with the orifice of the housing 20. The controller 40, or the valve of the controller 40, may be controlled by an engine control module (ECU). Moreover, the ECU may provide power or instructions to the controller 40 that results in the valve of the controller 40 moving between a first (or opened) position, and a second (or closed position), and vice versa.

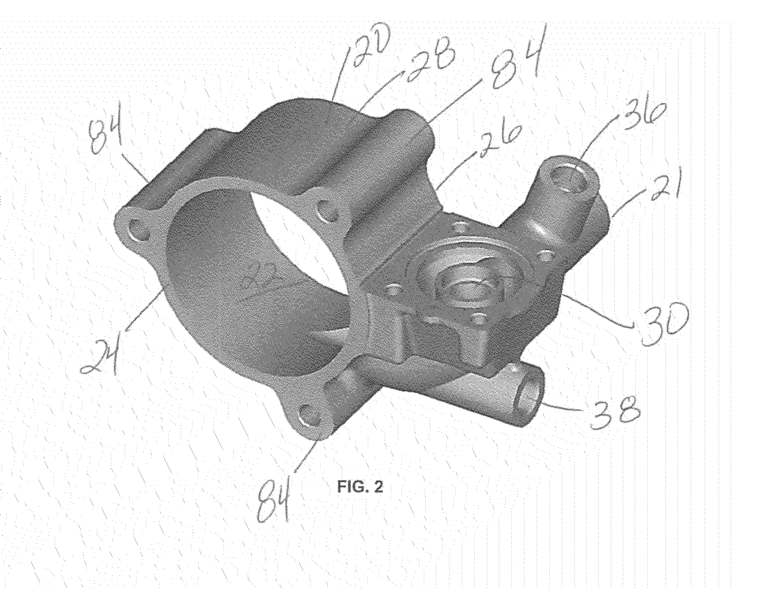

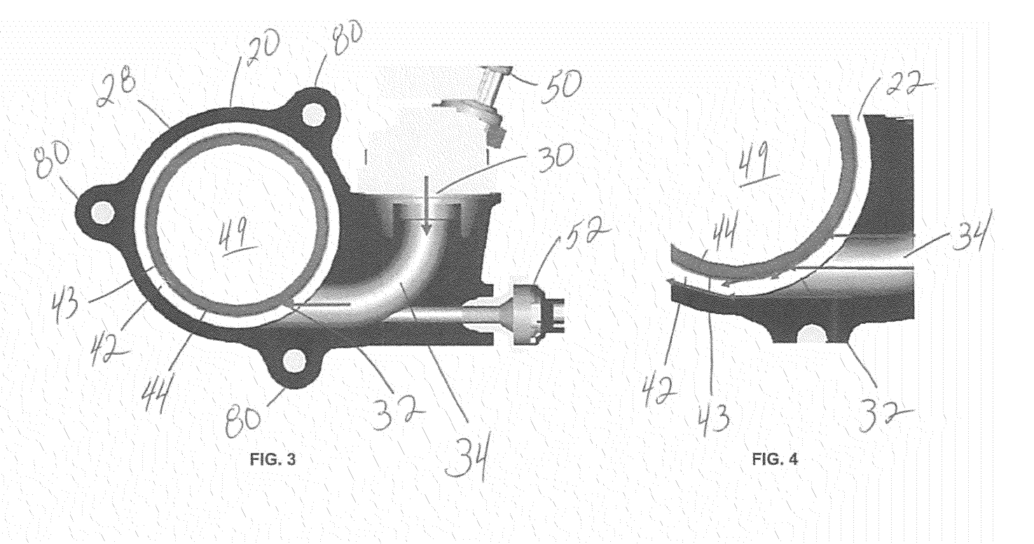

FIG. 2 is a perspective view of the housing 20 for the in-flow air injection system 10. As shown, the housing includes the orifice 22, a first side 24, a second side 26, an outer wall 28, and a supply inlet 30. The supply inlet 30 is positioned to receive supplemental gas that flows into the supplemental gas inlet 21 of the housing 20 when the valve of the controller 40 is in the first position. For example, the controller 40 is positioned relative to the supply inlet 30 such that when the valve of the controller 40 is in the second position, at least a portion of the valve may cover or plug the supply inlet 30 so that supplemental gas from the supply gas inlet 21 may not flow through the supply inlet 30. Moreover, when the valve of the controller 40 is in the first position, the valve of the controller 40 may be position so that supplemental gas may flow through the supply inlet 30. As shown in FIG. 3, supplemental gas flowing through the supply inlet 30 may be released into the orifice 22 through a supply outlet 32, with the supply inlet 30 and supply outlet 32 being in fluid communication with each other through an interconnecting supply gas pathway 34.

The housing 20 may also be configured for the placement of at least one pressure sensor. For example, as shown in FIGS. 1 and 2, the housing 20 may include an aperture 36 that is at least partially sized to receive the placement of a first sensor 50. The first aperture 32 may be in fluid communication with at least a portion of the supplemental gas inlet 21 such that the first sensor 50 may sense the pressure of the supplemental gas being delivered to the controller 40. As shown in FIG. 3, the housing 20 may also include a second aperture 38 that is at least in part configured to receive the placement of a second sensor 52. The second aperture 38 may be in fluid communication with the orifice 22 of the housing 20 such that the second sensor 52 may sense a pressure of EGR and/or supplemental gas in the orifice 22, the pressure of gases exiting the housing 20, or the pressure of the supplemental gas along an outer groove 42 of an inner ring 44, as discussed below. Information sensed by the first and/or second sensors 50, 52 may be delivered to the ECU.

As shown in FIGS. 3-6, the orifice 22 of the housing 20 is configured to receive the insertion of an inner ring 44. The inner ring 44 may be secured within the orifice 22, such as, for example, through the use of O-rings 54. The inner ring 44 may include a first sidewall 46, a second sidewall 48, a passage 49, and an outer groove 42. According to the illustrated embodiment, the outer groove 42 may be positioned along a portion of the outer circumference of the inner ring 42 and between at least an inside portion of the first and second sidewalls 46, 48.

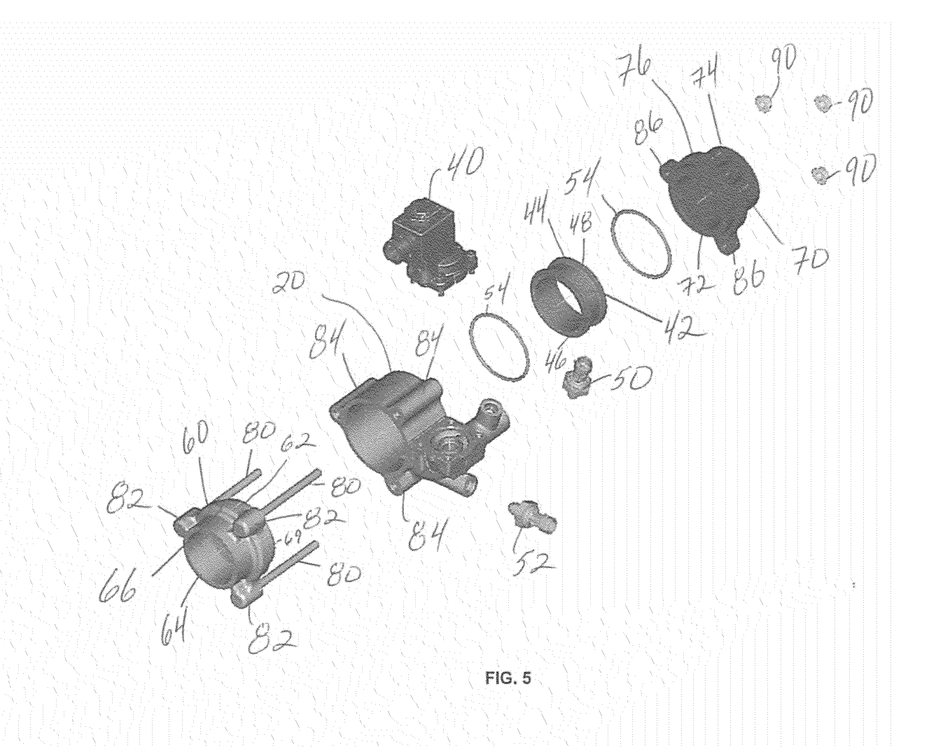

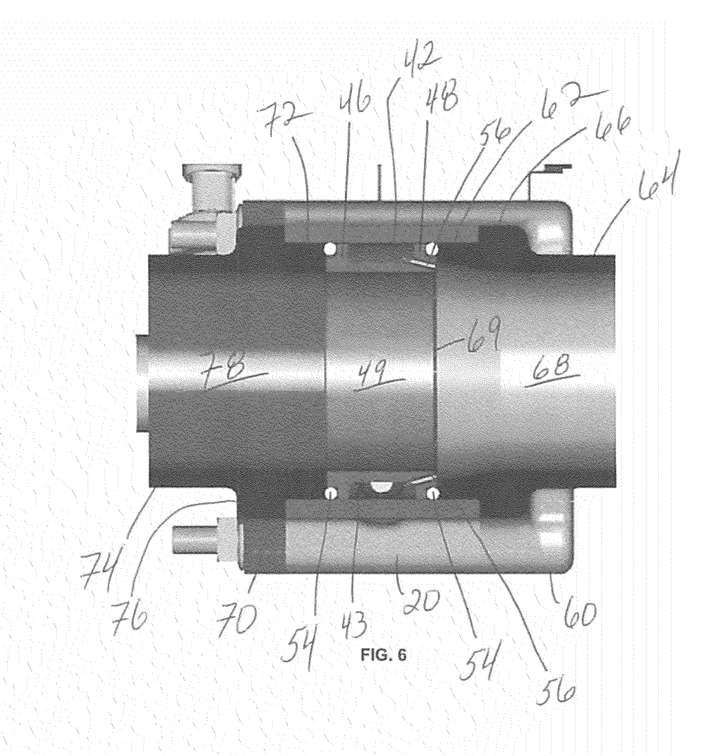

Referring to FIGS. 5-7, the housing 20 may be operably coupled to an intake manifold duct flange 60 and an EGR mixer duct flange 70. In the illustrated embodiment, the EGR mixer duct flange 70 provides a coupling between the housing 20 and duct work or tubes that supplies a gas or mixture of gases to the housing 20 that is to be delivered to the intake manifold so as to be present and/or used during the combustion process. Such combustion gas(es) may be or include, but are not limited to, air, exhaust gas, and/or a mixture thereof. According to the illustrated embodiment, the EGR mixer duct flange 70 may have an inner hub 72, an outer hub 74, and a shoulder portion 76. The outer hub 74 may be configured to be attached to the ductwork or tubing that is delivering a combustion gas. The EGR mixer duct flange 70 may also include a pathway 78 that allows combustion gas to flow through the EGR mixer duct flange 70. As shown in FIG. 6, according to the illustrated embodiment, when the EGR mixer duct flange 70, housing 20, and intake manifold duct flange 60 are coupled or assembled together, at least a portion of the inner hub 72 is positioned in the orifice 22 and adjacent to or abutting the second sidewall 48 of the inner ring 44. Moreover, the pathway 78 of the EGR mixer duct flange 70 is aligned with the passage 49 of the inner ring 44 so that combustion gas flows through the pathway 78 and into passage 49.

According to an embodiment, the intake manifold duct flange 60 includes a first hub 62, a second hub 64, and a shoulder region 66. The intake manifold duct flange 60 also includes a pathway 68 that extends through the intake manifold duct flange 60. The second hub 64 is connected to duct work or tubing that delivers gases that flow out of the housing 20 and through the pathway 68 to the intake manifold of the engine. The intake manifold duct flange 60 is position so that at least a portion of the pathway 68 is aligned with the passage 49 of the inner ring 44 so that gases exiting from or through the inner ring 44 are able to flow into the pathway 68. Further, according to the illustrated embodiment, at least a portion of the first hub 62 may be positioned inside of the orifice 22 of the housing 20. For example, as shown in FIG. 6, a first wall 69 of the first hub 62 may be adjacent to a portion of the second sidewall 48 of the inner ring 44.

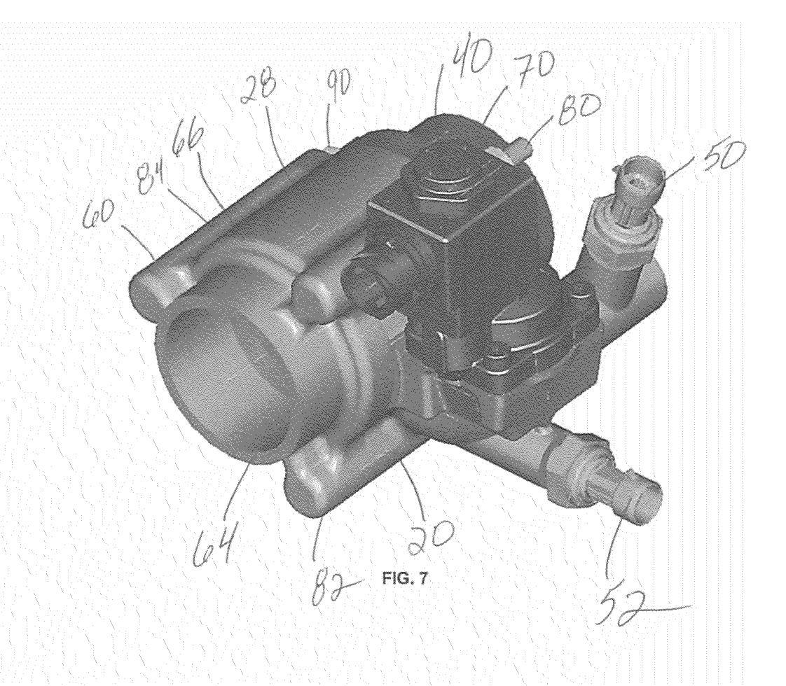

As shown in FIG. 7, according to the illustrated embodiment, the housing 20 may be coupled or assembled to the EGR mixer duct flange 70 and the intake manifold duct flange 60. For example, in the illustrated embodiments, bolts 80 may pass from or through openings in flanges 82 in the intake manifold duct flange 60, and through mating flanges 84, 86 in the housing 20 and EGR mixer duct flange 70. At least a portion of the bolts 80 may be threaded so that at least a portion of the bolt 80 that extends out of the flanges 86 of the EGR mixer duct flange 70 may be threadingly engaged by a nut 90. However, a variety of other attachment mechanisms or fasteners may be employed to secure the EGR mixer duct flange 70 and the intake manifold duct flange 60 to the housing 20. For example, the EGR mixer duct flange 70 and the intake manifold duct flange 60 may be separately connected to the housing 20, such as through the use of bolts, clips, or clamps, among other fasteners.

During normal engine operation, when the turbine is typically operating at sufficient speeds to drive the attached component, such as a compressor, and still provide the necessary suction for a combustion gas to be pulled through the pathway 68 of EGR mixer duct flange 70, the passage 49 of the inner ring 44, and through the pathway 68 of the intake manifold duct flange 60. In such situations, the ECU may be provided with information or data that allows the ECU to determine that the valve of the controller 40 on the in-flow air injection system 10 should be closed or remain closed, and thereby prevent the entry of supplemental gas into the supply inlet 30 of the housing 20.

However, in certain situations, the ECU or other diagnostic systems may determine that the valve of the controller 40 is to be in a first, or opened, position. For example, according to an embodiment, the ECU may determine and/or receive information indicating that the turbine is operating at speeds that are insufficient to draw desired amounts of exhaust gas or an air/exhaust gas mixture through the EGR system. For example, when turbine speeds are at or below around 400 RPMs, the turbine may be unable to generate sufficient suction to pull exhaust gas or an air/exhaust gas mixture through the EGR system. According to another embodiment, the ECU may receive information indicating combustion gas pressure along the EGR system, such as the pressure upstream, at, or downstream of the housing 20 has dropped below predetermined level, such as, for example, to a level at or below approximately 0 to 20 psi. According to another embodiment, the ECU may receive information indicating an insufficient quantity of exhaust gas is being mixed with the air in the EGR system and/or that is being used for the combustion process. Further, the ECU may receive information indicating the occurrence of detonation, or the occurrence of a predetermined number of detonations within a specified time period. In these situations (or combinations thereof), or under other circumstances, the ECU may determine that the valve of the controller 40 is to be in a first, or opened position. As discussed below, by moving the valve of the controller 40 into the first position, the supplemental gas may be used to pull combustion gas through the housing 20. Moreover, the use of the supplemental gas may allow for the creation of suction in the EGR system without depleting the power being generated by the turbine.

When the valve of the controller 40 is moved to the first position, supplemental gas is allowed to flow into the supply inlet 30, through the supply gas pathway 34, and through the supply outlet 32. The supplemental gas exiting the supply outlet 32 flows into the outer groove 42 of the inner ring 44. The supply outlet 32 may be positioned so as prevent or minimize the degree to which supplemental gas splits into different or divergent directions if the gas exiting the supply outlet 32 is directed towards the bottom surface 43 of the outer groove 42. For example, positioning the supply outlet 32 such that supplemental gas flowing out of the outlet 32 is directed toward a bottom surface 43 of the outer groove 42 at an approximately 90 degree angle may cause the flow of the supplemental gas to spilt in a number of different, and possibly in divergent directions. Such splitting may adversely impact the velocity of the supplemental gas flowing about the outer groove 42. Therefore, in an effort to minimize any reduction in the velocity of the supplemental gas flowing about the outer groove 32, the supply outlet 32 may be configured and/or positioned to minimize the potential for such splitting of the supplemental gas.

For example, as illustrated by the flow arrows in FIGS. 3 and 4, the supply outlet 32 may be positioned relative to the inner ring 44, and more specifically to the outer groove 42, so as to minimize the amount of supplemental gas that is direct from the supply outlet 32 towards the bottom surface 43. Further, the supply outlet 43 may be positioned such that at least a substantial portion of the supplemental gas flowing out of the supply outlet 32 that encounters the bottom surface 43 is re-directed in generally the same direction. For example, as shown in FIG. 4, in the illustrated embodiment, the supply outlet 32 may be positioned so as to assist in directing the flow of the supplemental gas exiting the outlet 32 in a clockwise direction along the outer groove 42.

The supplemental gas flowing along the outer groove 42 may then flow through one or more air jets 56 positioned along portions of the second sidewall 48 of the inner ring 44 and into the passage 49 of the inner ring 44 or the pathway 68 of the intake manifold duct flange 60. In the illustrated embodiment, the air jets 56 may be arranged in a generally annular configuration about the second sidewall 48. According to one embodiment, the second sidewall 48 may have eight air jets 56. Further, according to certain embodiments, the air jets 56 may be relatively narrow in size such that, when supplemental gas flowing about the outer groove 42 flows through an air jet 56, the velocity of the supplemental gas increases while the pressure of the gas decreases. The momentum of supplemental gas flowing through the air jets 56 and/or the friction between the supplemental gas being delivered through the air jets 56 with combustion gas may cause additional combustion gas to be drawn into the housing through the EGR mixer duct flange 70.

When the turbine resumes operating at sufficient speeds to provide the power for drawing or pulling combustion gases through the housing 20, the ECU or other control module may stop the flow of supplemental gases through the housing 20 and inner ring 44 by having the valve of the controller 40 move to a second, or closed, position. By placing the valve of the controller 40 in the second position, the supplemental gas is prevented from continuing to flow into the supply inlet 30 until the controller 40 moves, or is instructed to move, the valve back to the first, or open, position.

The flow of supplemental gases may also be necessary even when a sufficient quantity of combustion gases, or a sufficient mixture of such gases, is flowing to the intake manifold. For example, the supplemental gases may be used for maintenance purposes, such as, for removing soot from narrow air jets 56 and/or the housing 20.

1. An apparatus for an in-flow air injection system comprising:
a housing having an orifice configured to receive the placement of an inner ring, the inner ring having a first sidewall, a second sidewall, an outer groove, and at least one air jet, the outer groove being positioned between at least a portion of the first and second sidewalls, the housing further including a supplemental gas inlet, a supply inlet, and a supply outlet, the supply inlet and the supply outlet being in fluid communication through a supply gas pathway, the supply inlet being configured to receive a supplemental gas that flows through the supplemental gas inlet, the supply outlet being positioned to deliver the supplemental gas received by the supply inlet to the outer groove.

2. The apparatus of claim 1, wherein the housing further includes a first aperture that is in fluid communication with the supplemental gas inlet, at least a portion of the first aperture being configured to receive the placement of a first pressure sensor.

3. The apparatus of claim 2, wherein the housing further includes a second aperture that is in fluid communication with the outer groove of the inner ring, at least a portion of the second aperture being configured to receive the placement of a second pressure sensor.

4. The apparatus of claim 1, further including a controller that is operably attached to the housing, the controller being configured to control the passage of supplemental gas into the supply inlet.

5. The apparatus of claim 1, wherein the supply outlet is positioned to minimize the splitting in direction of the supplemental gas that is exiting the supply outlet.

6. The apparatus of claim 1, wherein the housing is configured to be coupled to an intake manifold duct flange, the intake manifold duct flange providing a coupling between the housing and ductwork that delivers gases to an intake manifold of an internal combustion engine.

7. The apparatus of claim 6, wherein the housing is configured to be coupled to an exhaust gas mixer duct flange, the exhaust gas mixer duct flange providing a coupling between the housing and the ductwork of exhaust gas recirculation system that delivers combustion gas to the housing.

8. An apparatus for an in-flow air injection system comprising:
a housing having an orifice configured to receive the placement of an inner ring, the inner ring having a first sidewall, a second sidewall, an outer groove, and at least one air jet, the outer groove being positioned between at least a portion of the first and second sidewalls, the housing further including a supplemental gas inlet, a supply inlet, and a supply outlet, the supply inlet and the supply outlet being in fluid communication through a supply gas pathway, the supply inlet being configured to receive a supplemental gas that flows through the supplemental gas inlet, the supply outlet being positioned to deliver the supplemental gas received by the supply inlet to the outer groove, the housing also including at least one aperture, at least a portion of the at least one aperture being configured to receive a sensor that senses a gas pressure within the housing.

9. The apparatus of claim 8, wherein at least one aperture is in fluid communication with the supplemental gas inlet.

10. The apparatus of claim 8, wherein at least one aperture is in fluid communication with the outer groove of the inner ring.

11. The apparatus of claim 8, further including a controller that is operably attached to the housing, the controller being configured to control the passage of supplemental gas into the supply inlet.

12. The apparatus of claim 8, wherein the housing is configured to be coupled to an intake manifold duct flange, the intake manifold duct flange providing a coupling between the housing and ductwork that delivers gases to an intake manifold of an internal combustion engine.

13. The apparatus of claim 8, wherein the housing is configured to be coupled to an exhaust gas mixer duct flange, the exhaust gas mixer duct flange providing a coupling between the housing and the ductwork of exhaust gas recirculation system that delivers combustion gas to the housing.

14. A method for controlling the pressure of combustion gas passing through an in-flow injection housing in an EGR system comprising:
determining a speed of a turbine;
opening a supply inlet in the in-flow injection housing when the speed of the turbine is below a predetermined limit;
delivering a supplemental gas through the supply inlet of the in-flow injection housing and to an outer groove of an inner ring that is positioned in an orifice of the in-flow injection housing;
supplying the supplemental gas from the outer groove through a plurality of air jets to a passage of the inner ring;
drawing combustion gases through the in-flow injection housing through the supply of supplemental gas through the plurality of air jets; and
closing the supply inlet when the turbine attains a predetermined speed.

15. The method of claim 15 further including the step of sensing the pressure of the supplemental gas along the outer groove.
